(19) United States
(12) Patent Application Publication
(10) Pub. No.: US 2005/0030628 A1
(43) Pub. Date: Feb. 10, 2005

(54) Very low cost narrow band infrared sensor

(75) Inventors: Matthias Wagner, Cambridge, MA (US); Eugene Yi-Shan Ma, Chestnut Hill, MA (US); Lawrence H. Domash, Conway, MA (US); David Loeber, Plainville, MA (US); Mitchell S. Cohen, Bedford, MA (US)

Correspondence Address: WILMER CUTLER PICKERING HALE AND DORR LLP, 60 STATE STREET, BOSTON, MA, 02109, US

(73) Assignee: Aegis Semiconductor, Woburn, MA (US)

(21) Appl. No.: 10/872,764

(22) Filed: Jun. 21, 2004

Related U.S. Application Data
(60) Provisional application No. 60/480,294, filed on Jun. 20, 2003.
(60) Provisional application No. 60/509,379, filed on Oct. 7, 2003.

(51) Int. Cl. G02B 5/18

(52) U.S. Cl. 359/573; 359/288

(57) ABSTRACT

An optical sensor for detecting a chemical in a sample region includes an emitter for producing light, and for directing the light through the sample region. The sensor also includes a detector for receiving the light after the light passes through the sample region, and for producing a signal corresponding to the light the detector receives. The sensor further includes a thermo-optic filter disposed between the emitter and the detector. The optical filter has a tunable passband for selectively filtering the light from the emitter. The passband of the optical filter is tunable by varying a temperature of the optical filter. The sensor also includes a controller for controlling the passband of the optical filter and for receiving the detection signal from the detector. The controller modulates the passband of the optical filter and analyzes the detection signal to determine whether an absorption peak of the chemical is present.

### CROSS-REFERENCE TO RELATED APPLICATIONS

This application claims benefit U.S. Provisional Patent Application Ser. No. 60/480,294, filed Jun. 20, 2003, and U.S. Provisional Patent Application Ser. No. 60/509,379, filed Oct. 7, 2003.

### TECHNICAL FIELD

This invention relates generally to chemical sensors.

### BACKGROUND

One category of chemical sensors is used to detect low concentrations of a particular gas in a sample region. Typical target gases include CO₂, CH₄, and CO, among others. This category includes many different sensor technologies, including catalytic combustion, electro-chemical, photo ionization, flame ionization, IR absorption, metal oxide, thermal conductivity, and calorimetric. Of these technologies, the optical ones (absorption in particular) are most precise, but are usually too expensive for consumer applications. Prior art consumer sensors therefore typically use less expensive electro-chemical sensors instead of optical sensors. Electro-chemical sensors, however, suffer from non-specific response, finite lifetime, and are generally inaccurate. A low cost, robust optical gas sensor would be of commercial importance for HVAC, households, automotive, etc.

In general, optical sensors are classified as dispersive (spectrometers) or non-dispersive, the latter makes use of light that is either narrowband (laser or narrowband LED) or provided with a narrowband filter so as to produce narrowband light. An optical chemical sensor uses light filtered so as to provide an emission profile that matches the absorption profile of the chemical. The sensor directs the light through a sample region where the chemical may be present, and determines whether and by how much the transmission through the region attenuates the light at the absorptive wavelength. The amount of attenuation depends upon the concentration of the chemical in the region, and the path length of the light through the region.

Sensing a toxic trace gas (such as CO) requires detecting very small concentrations of the gas (e.g., 50 ppm or less). For the example of CO, which has a band of rotational absorption lines from 4420 to 4900 nm, the absorption at this wavelength in traversing a path of 1 meter may be as little as 0.1 percent. Such a small absorption is difficult to detect reliably. Optical detection in such sensing environment therefore requires a precise comparison or differential measurement. The comparison could be over a single light path using two fixed filters, one of which matches the absorption and one of which does not. The comparison could alternatively use a single filter, but compare two optical paths, one of which propagates a relatively long distance through the gas and the other a shorter distance. A third approach could use a tunable laser to direct very narrow band light through the sample region, and vary the wavelength of the light on and off of the chemical absorption peak. A tunable laser, however, tends to be relatively expensive, and is not a suitable choice for low cost applications (e.g., CO and CO₂ monitoring devices).

A less expensive optical chemical sensor alternative to a tunable laser is shown in FIG. 1. An IR source 12 directs light with a relatively broadband spectrum through a sample gas 14, through a number of bandpass filters 16a-16d, and to a number of detectors 18a-18d. Each of the bandpass filters (except the reference filter, 16d) has a passband with a center wavelength corresponding to the absorption peak of a different chemical. In this example, the center wavelength of filter 16a corresponds to the absorption peak of CH₄, the center wavelength of filter 16b corresponds to the absorption peak of CO₂, the center wavelength of filter 16c corresponds to the absorption peak of CO, and the center wavelength of filter 16d (the reference path) is a wavelength outside of the absorption profiles of CH₄, CO₂ and CO. In some cases, the optical chemical sensor does not use the reference filter 16d, so that the reference detector 18d receives the entire spectrum of the IR source 12.

Each of the detectors 18a-18d provides a signal to the control and sensing electronics 20. The control and sensing electronics 20 compares the signal from each of the gas detectors 18a-18c to the signal from the reference detector 18d. A reduced signal level from a gas detector (as compared to the signal from the reference detector) indicates the presence of the corresponding gas.

### SUMMARY OF THE INVENTION

In one aspect, an optical sensor for detecting a chemical in a sample region includes an emitter for producing broadband light having a broadband spectrum. The light travels along a light path that passes through the sample region. The sensor also includes a detector for producing a detection signal corresponding to the light the detector receives. The detector is disposed in the light path. The Sensor further includes an optical filter having a tunable passband for selectively filtering the light traveling in the light path. The passband of the optical filter is tunable by varying a temperature of the optical filter. One embodiment includes a controller for controlling the passband of the optical filter. The controller modulates the passband of the optical filter across a wavelength range. The controller also receives the detection signal from the detector, analyzes the detection signal to determine whether an absorption peak of the chemical is present.

In one emobodiment, the emitter and the optical filter are thermally coupled, so that varying a temperature of the emitter correspondingly varies the temperature of the optical filter, thereby tuning the optical filter in wavelength. The emitter and optical filter may be thermally coupled through thermal radiation or through thermal conduction, or some combination thereof.

The optical filter may include a heating element for varying the temperature of the optical filter independent from the emitter. The emitter may include a thin film membrane mounted on a first substrate frame, with the emitter and optical filter are bonded together, so as to form a tunable optical emitter (TOE). In another embodiment the optical filter is disposed in close proximity to the detector, so as to form a tunable optical detector (TOD).

In one embodiment, the controller periodically modulates the passband at a predetermined frequency about an absorption peak of the chemical, and analyzes the detection signal for a variation corresponding to the absorption peak of the chemical. In another embodiment, the controller analyzes the detection signal using a lock-in detection technique. In yet another embodiment, the controller evaluates a derivative of the detection signal as the controller modulates the center wavelength of the optical filter, and averages the derivative of the detection signal for two or more passband modulation cycles to detect an absorption peak of the chemical.

In one embodiment, the emitter, the detector and the optical filter are disposed in close proximity to form an emitter/detector/filter combination. The sensor further includes a retro-reflector for reflecting the light back to the combination, and the controller calculates an amount of power necessary to change the temperature of the optical filter. The controller determines whether an absorption peak of the chemical is present from that calculated amount of power.

In another embodiment, the emitter and the detector are disposed in close proximity to form an emitter/detector combination. The sensor further includes a controller for controlling the passband of the optical filter and for receiving the detection signal from the detector. The controller calculates an amount of power necessary to change the temperature of the optical filter, and determines whether an absorption peak of the chemical is present from the calculated amount of power.

In another aspect, a tunable optical emitter for producing light having a wavelength spectrum that is translatable across a range of wavelengths includes an optical source for producing light having a first wavelength spectrum. The tunable optical emitter further includes an optical filter having a tunable passband for selectively filtering the light from the optical source. The optical filter receives light from the optical source and produces filtered light having a second wavelength spectrum, such that the first wavelength spectrum includes the second wavelength spectrum. The passband of the optical filter is tunable by varying a temperature of the optical filter.

In on embodiment, the optical source and the optical filter are thermally coupled, so that varying a temperature of the optical source correspondingly varies the temperature of the optical filter. The thermal coupling may be via radiation or conduction or some combination thereof. In another embodiment, the optical filter includes a heating element for varying the temperature of the optical filter independent of a temperature of the optical source.

In one embodiment, the optical source includes a thin film membrane on a first silicon frame, and the optical source and optical filter are bonded together.

In another aspect, an optical filter membrane structure having a tunable passband includes a filter membrane of two or more stacked thin film layers forming at least one resonant cavity on a substrate frame. The passband is tunable by varying a temperature of the filter membrane. The optical filter membrane structure further includes a heater associated with the filter membrane for tuning the passband across a wavelength range. The heater may include a ring heater structure formed on the top of the filter membrane, or the heater may include a radiative emitter radiating IR radiation toward the filter membrane.

In one embodiment, the filter membrane is formed by depositing the two or more stacked thin film layers on a front surface of a silicon wafer, and etching away an aperture on the back surface of the silicon wafer, such that a remaining portion of the silicon wafer forms a silicon frame around a filter membrane.

In one embodiment, the filter thin film membranes include germanium. In another embodiment, the filter membranes include silicon.

### BRIEF DESCRIPTION OF THE DRAWINGS

FIG. 1 shows a prior art optical chemical sensor.

FIG. 2a shows a first TOE embodiment

FIG. 2b shows temperature versus time for emitter and filter of the TOE in FIG. 2a.

FIG. 2c shows a second TOE embodiment.

FIG. 2d shows temperature versus time for emitter and filter of the TOE in FIG. 2c.

FIG. 3a shows blackbody emission versus wavelength.

FIG. 3b shows the spectral emission of a tunable filter at three states of tuning, compared with the absorption spectrum of CO.

FIG. 3c shows the graph of FIG. 3b including the effect of temperature dependent absorption of germanium.

FIG. 4a shows an embodiment of a CO gas sensor.

FIGS. 4b and 4c show an embodiment of a packaged tunable filter.

FIG. 5a shows a structure for fabricating a membrane filter, prior to etching.

FIG. 5b shows a membrane filter after etching.

FIG. 5c shows a top view of the filter in FIG. 5a.

FIGS. 6a through 6f show alternative embodiments of the sensor of FIG. 4a.

FIGS. 7 through 9 show alternative embodiments of the sensor of FIG. 4a.

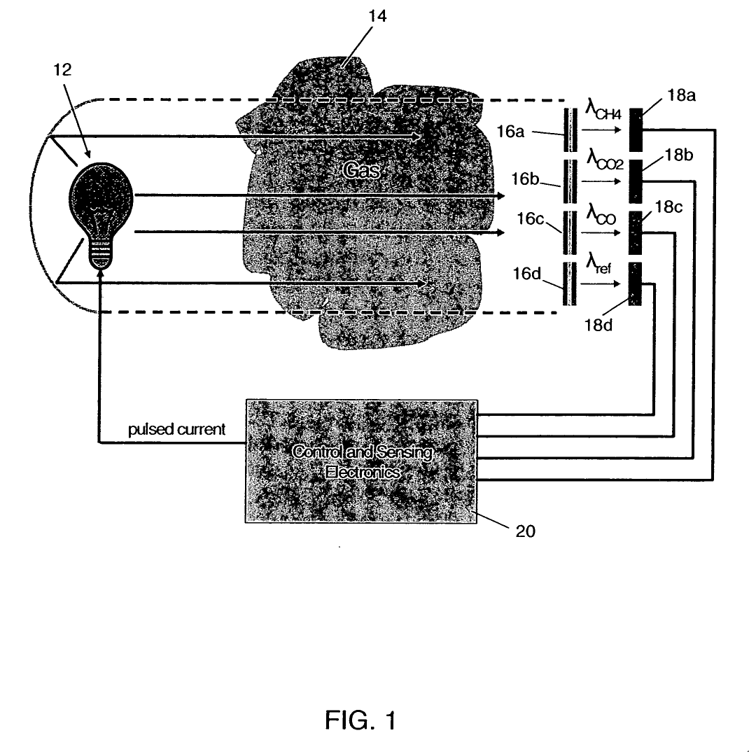

### DETAILED DESCRIPTION

The described embodiment is a CO gas sensor that uses a tunable optical emitter (TOE) to direct narrow band infrared (IR) light through a gas sample and onto a detector. The sensor modulates the wavelength of the IR light back and forth across the CO spectral absorption features, i.e., from about 4500 nm to about 4700 nm.

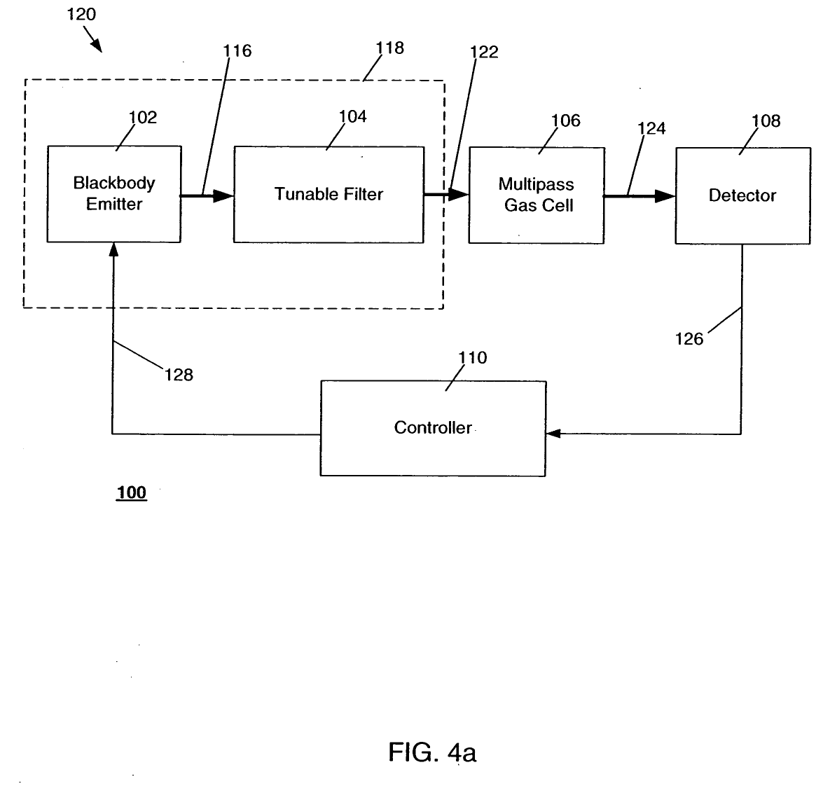

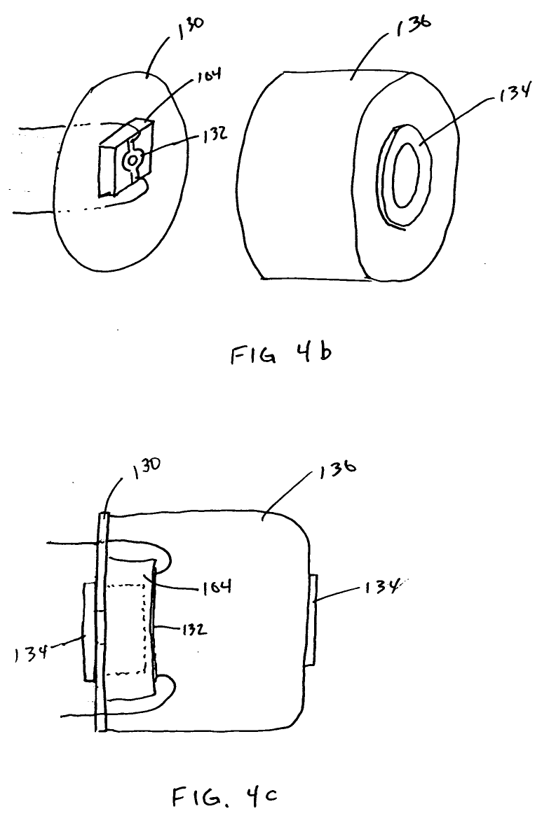

As is described in more detail below, the TOE includes a blackbody emitter that is associated with a thermo-optic tunable filter, either by close proximity with little or no thermal coupling, or by direct integration so that the emitter and filter are thermally coupled. In FIG. 4a (described in detail below), the broken-lined box 118 represents the association between the emitter and the filter, so as to form a tunable light source (i.e., a TOE), including a blackbody emitter as a low-cost light source, together with a tunable thermo-optic filter. This TOE concept encompasses (but is no limited to) two main embodiments.

One TOE embodiment arranges a fixed emitter with a constant output spectrum and magnitude to back-illuminate a tunable optical filter. The emitter and filter may be arranged in a single package, such as a can or other suitable electronics package known in the art. The tunable optical filter is includes its own heating mechanism for tuning, independent of the emitter. The emitter is typically at a constant, relatively high temperature (somewhere, for example, between 500° C. to 100020 C.) for intense emission, whereas the filter temperature is much lower to preserve its material integrity, and varies over a range of temperatures, for example from 25° C. to 4000° C. for the purpose of tuning. A wavelength-to-temperature tuning rate of 0.6 nm/° C. is typical for germanium materials and mid-IR design. More generally, wavelength-to-temperature tuning rates are typically given by 1.3×10⁻⁴ of the center wavelength/° C. for germanium, and 6×10⁻⁵ of center wavelength per degree for silicon.

In the case of a fixed emitter mounted in proximity to a tunable filter with an independent heating resistor incorporated in the filter structure, it is important that the emitter be somewhat thermally isolated from the filter, so as not to affect its tuning by proximity. This can be done by providing a sufficient distance between the elements and by proper packaging.

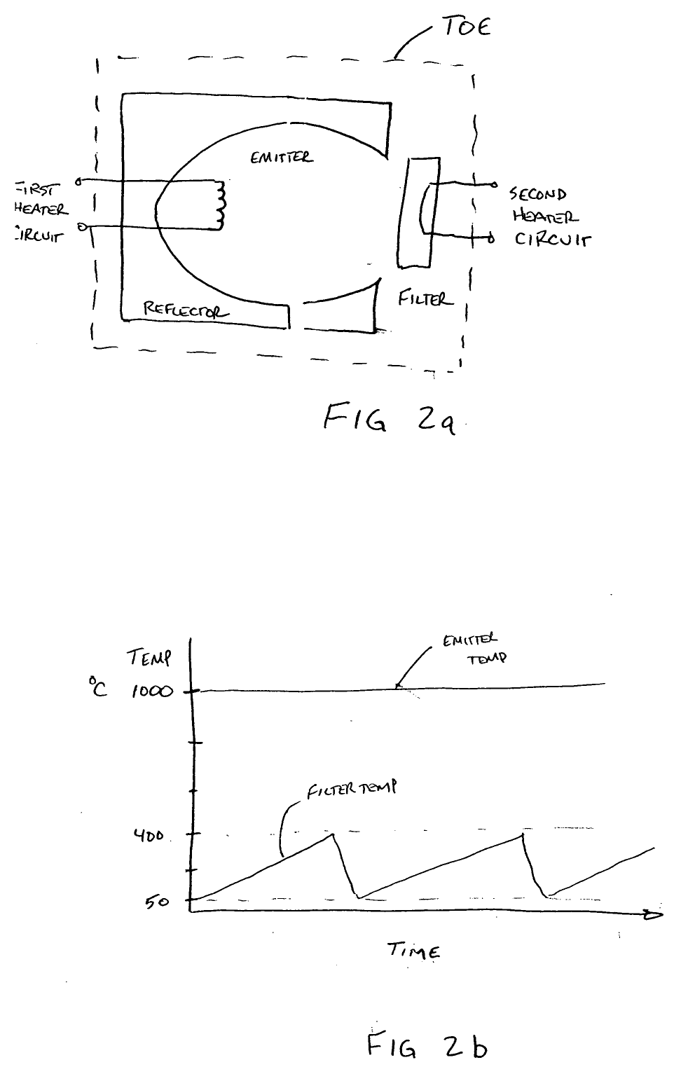

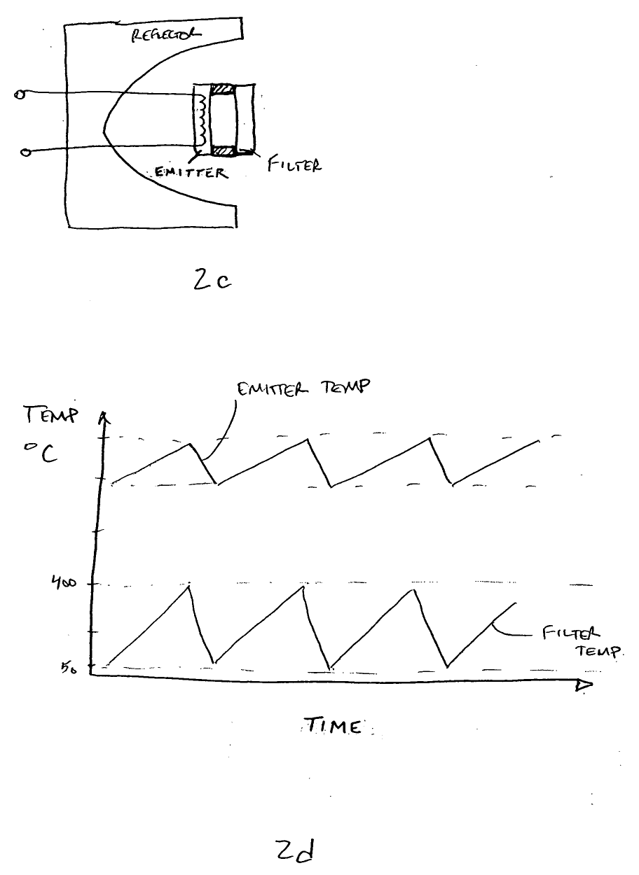

Providing metal parabolic, elliptical or other shaped back-reflectors to concentrate the IR emission and guide it to the filter aperture, as shown in FIG. 2a, improves the efficiency of all such emitters. An elliptical filter as shown in FIG. 2a may be used to refocus light from the emitter to the input aperture of the filter. FIG. 2b shows that during the scanning process, the emitter temperature stays constant while the filter is ramped in temperature via its independent heater circuit. This tunable optical filter embodiment has limited potential for miniaturization, due to the need to isolate the hot emitter from the heat driven filter. If the emitter is too close to the filter, the temperature of the filter cannot be controlled independent of the emitter.

A second embodiment of the TOE, referred to herein as the Integrated TOE (ITOE), includes a filter is thermally coupled with an IR emitter, either through extremely close proximity, or by attaching the filter to the emitter via a bonding material or other securing technique (see FIG. 2c). As with the first TOE embodiment described above, the emitter and filter of the ITOE may also be arranged in a single package, such as a can or other suitable electronics package known in the art. A parabolic reflector with the TOE at the reflector focal point, as shown in FIG. 2c, directs the emission toward the gas and detector. The thermal coupling causes the filter to be heated (an hence tuned) directly by the emitter, so that the filter does not need its own internal heating component or independent heating circuit. Although the thermal coupling may include radiative and conductive coupling, radiative coupling is preferred over conduction because radiative coupling allows a greater change in temperature with respect to time. In this embodiment, the emitter temperature is periodically varied instead of operating at a constant temperature, between for example 800 C and 1000 C, causing the filter through the thermal coupling to be heated between for example 100 C and 400 C (see FIG. 2d). The relationship between the emitter temperature range and the filter temperature range is arranged by proper structure and dimensioning, and by providing the filter with suitable layers that absorb wavelengths the filter does not transmit, thereby enhancing its coupling to the emitter. Other embodiments may use different temperature ranges and relationships. Only one heater circuit is necessary, for the emitter, which indirectly tunes the filter as it cyclically heats the emitter. The result is a fully integrated tunable emitter, which can be very small, so as to fit inside, for example, a TO5 can package.

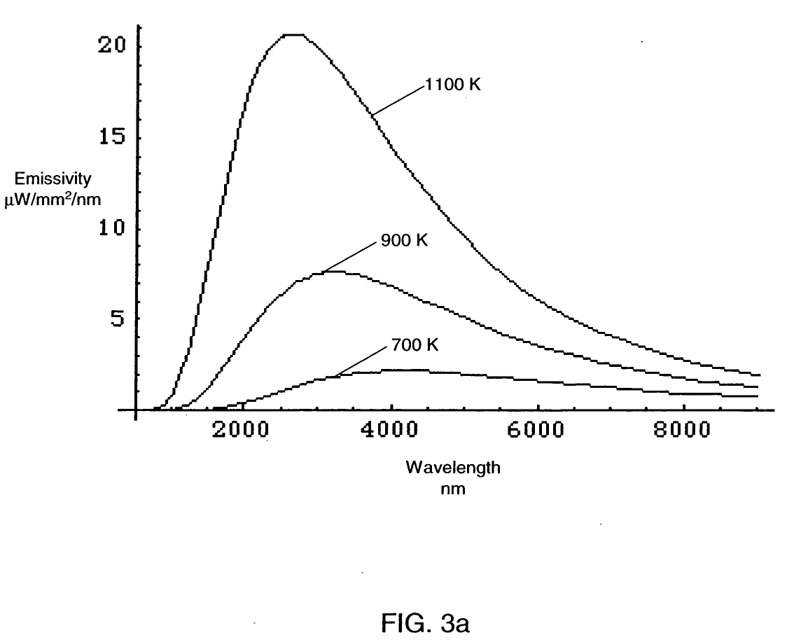

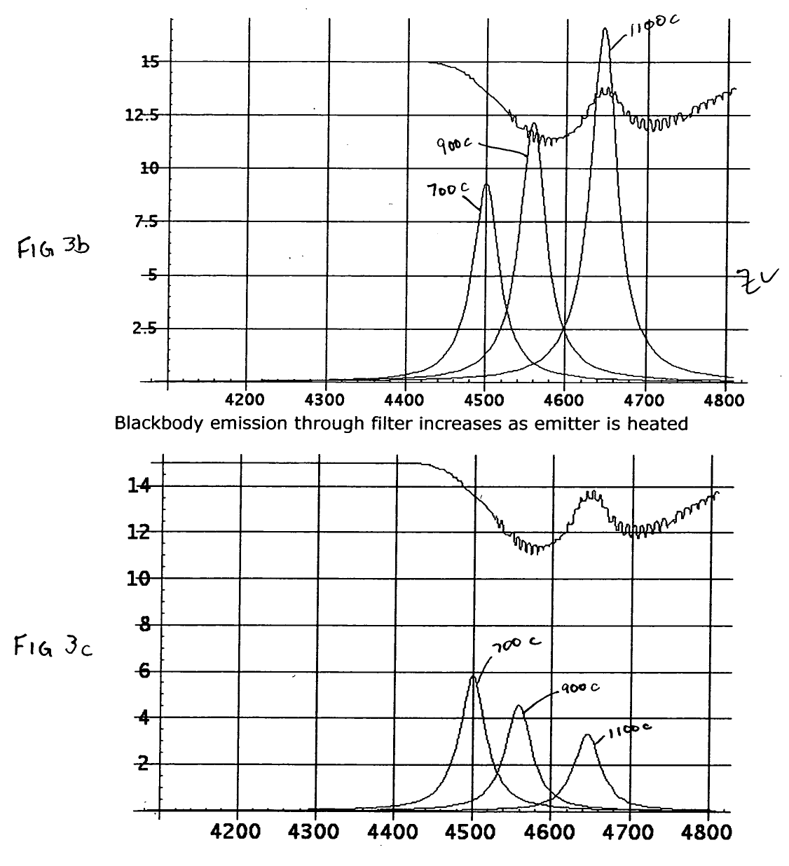

It is well known that as the temperature of a blackbody emitter increases, its emission at any given wavelength will rise in proportion to its temperature, as shown in FIG. 3a. One might therefore expect that the output of the tunable emitter of FIG. 2c would also increase as it tunes as shown in FIG. 3b. Such variations in output power are undesirable, especially if the variations are excessive. However, the transmissivity of germanium decreases as its temperature increases. So for filters that use germanium films, the decrease in filter transmissivity tends to offset the increased blackbody illumination as the emitter heats (and hence tunes) the filter, resulting in constant or nearly constant output intensity, as shown in FIG. 3c. The filter itself is also a blackbody emitter, which further contributes to the overall intensity increase with respect to temperature. These three factors may be combined to produce a TOE with constant or nearly constant output intensity as the TOE scans through the desired wavelengths. Small output variations can be compensated at or after the detector via electronic techniques known in the art.

The CO gas sensor tunes the TOE using a thermal mechanism, taking advantage of the thermo-optic properties of its constituent films. The thermo-optic filter is relatively inexpensive to fabricate by known techniques for thin film deposition, such as e-beam deposition, sputtering, and plasma enhanced chemical vapor deposition (PECVD). Further, relatively simple design variations provide a wide range of bandwidths. Incorporating a TOE in a chemical sensor is therefore a low cost and volume-manufacturable approach to IR tunable filters and can be applied over a broad range of target wavelengths.

Referring to FIG. 4a, one embodiment a CO gas sensor 100 includes a blackbody emitter 102, a tunable filter 104, a multipath gas cell 106, a detector 108 and a controller 110. The blackbody emitter 102 provides broadband, blackbody radiation to the tunable filter 104. The controller 110 causes the tunable filter 104 to scan its transmission across a range of wavelengths corresponding to the CO absorption profile. The tunable filter 104 filters the light from the emitter 102 so as to produce filtered light with a spectrum that also scans across the same range of wavelengths. The filtered light from the tunable filter 104 enters the multipath gas cell 106, which is designed-to allow the filtered light to pass numerous times through the gas sample within the gas cell 106. The detector 108 receives light from the gas cell 106 after the light has passed through the gas sample, and produces a detection signal corresponding to the light it receives. The controller 110 analyzes the detection signal to determine if an absorption peak is present.

The following paragraphs provide more detailed descriptions of each of the components in this CO gas sensor 100.

The blackbody emitter 102 (also referred to herein as a blackbody source) produces electromagnetic energy that has a relatively wide blackbody spectrum as shown in FIG. 2a. The blackbody emitter 102 emits infrared light 116 toward the tunable filter 104. In the described embodiment, the blackbody emitter 102 is a silicon substrate with one or more electrically conductive layers of thin silicon or diamond-like carbon deposited via chemical vapor deposition (CVD) or other thin film deposition technique. An interior portion of the back surface of the silicon substrate is completely etched away to leave only a thin film emitter in a silicon frame. This structure results in an emitter with relatively low thermal inertia that can support rapid temperature changes. Electrical contacts are deposited on the outer edges of the thin film. The thin film emitter is heated by applying an electrical potential across these electrical contacts, thereby causing a current to flow through the electrically conductive film.

Various alternative emitter structures may be selected for long life, low cost, and intense IR output. Also, the smallest possible emitter is desired in order to provide efficient optics. Such emitters include conductively doped silicon chips, thin silicon membranes, thin membranes of diamond like carbon, or coils or filaments of metal (as used herein, a “membrane” may include a single thin film layer, or it may include multiple thin film layers stacked upon one another). A miniature incandescent light bulb of tungsten wire is also a possible emitter, but its glass envelope will block most of the mid IR radiation. Alloys of Cr with Ni, Fe, or Al (such as “nichrome” or “kanthal”) are good choices for the metal coil or filament emitter, because they can operate in air at 1000 C or more with long life, without requiring windows which would otherwise block IR emission between 4000 to 5000 nm.

The blackbody emitter 102 may include a silicon surface that is textured with micron-level features, resulting in a somewhat narrower blackbody spectrum as compared to a simple silicon film. The narrower blackbody spectrum allows a more efficient use of the power supplied to the emitter, since less out-of-band IR energy is wasted. See, for example, “Tuned IR emission from lithographically defined silicon surfaces,” Daly et al, Mat. Res. Soc. Symp. OOO4.7, Boston, 1999.

The tunable filter 104 is a thermo-optic filter that provides a bandpass transmission response in the CO absorption feature range. In general, the tunable optical filters described herein are narrowband bandpass filters developed by Aegis Semiconductor, Inc., extensively for the telecommunications industry for applications at or near 1500 nm. As described in earlier patents and publications (see, for example, Journal of Lightwave Technology, January 2004) these filters can be single or multi-cavity, Fabry-Perot line-shape or flat top line-shape, and can operate at various bandwidths. Such filters are tunable by heating or cooling with internal conductive films or metal resistor films. The embodiments described herein extend this technology, primarily developed for use at 1.5 micron and using amorphous silicon, to longer wavelengths 3-12 micrometers for use in gas sensing. The underlying principles are much the same except that germanium is used in place of silicon in many cases for mid-IR applications, due to the superior transmissivity of germanium at mid-IR wavelengths, and the larger wavelength-to-temperature tuning rate of germanium.

For mid IR range use (roughly 2 to 5 microns wavelength), the tunable filter 104 is made of thin films of germanium and silicon monoxide deposited on a Silicon On Insulator (SOI) wafer. The thin film filter as such is designed and fabricated using well-known methods. For example, in the described embodiment, the filter 104 is designed with a thin film structure of three resonant cavities, approximately 20 layers, and displays a ‘square’ transmission region that is about 0.1 micron wide (100 nm) at 4.55 microns wavelength, within which it is about 90% transmissive. This particular number of cavities, number of layers, and set of dimensions is only an exemplary case for the purposes of this description, and other constructions may also be used. Examples of such thermo-optically tunable thin film filters are described in U.S. Patent Application No. 60/509,379, Tunable Filter Membrane Structure, filed Oct. 7, 2003, which is incorporated by reference in its entirety.

FIGS. 4b and 4c show an embodiment of a thermally tunable filter 104 in a TO8 can package. The filter 104 is mounted on a header 130, which functions as the base of the can package. Wire bonds connect the heater ring 132 on the filter 104 to pins in the header 130. Blocking filters 134 on the top of the can 136 and on the header 130 allow light within only a bandwidth from about 4000 nm to 5000 nm to pass, thereby excluding extraneous out-of-band light.

The tunable filter 104 is tuned by varying its temperature. In an illustrative case of a germanium-based filter with center wavelength of 4.45 microns, the coefficient of change of center wavelength with temperature is about 0.6 nm per degree C., or 60 nm for each 100 degrees C. The CO absorption band has a double peak structure from about 4420 to 4900 nm. Sensing takes place by tuning the filter 104 over the slope that exists near the CO absorption peak from 4450 to 4570 nm, a tuning range of 120 nm, which implies temperature tuning the filter over a range of 200 degrees C. Other selections of wavelength variations may be used for particular applications (i.e., detecting other chemicals) or to solve particular problems. For example, a CO2 absorption characteristic occurs just on the short wavelength side of the CO absorption peak, so tuning between two slightly higher wavelengths may avoid interference from CO2 absorption.

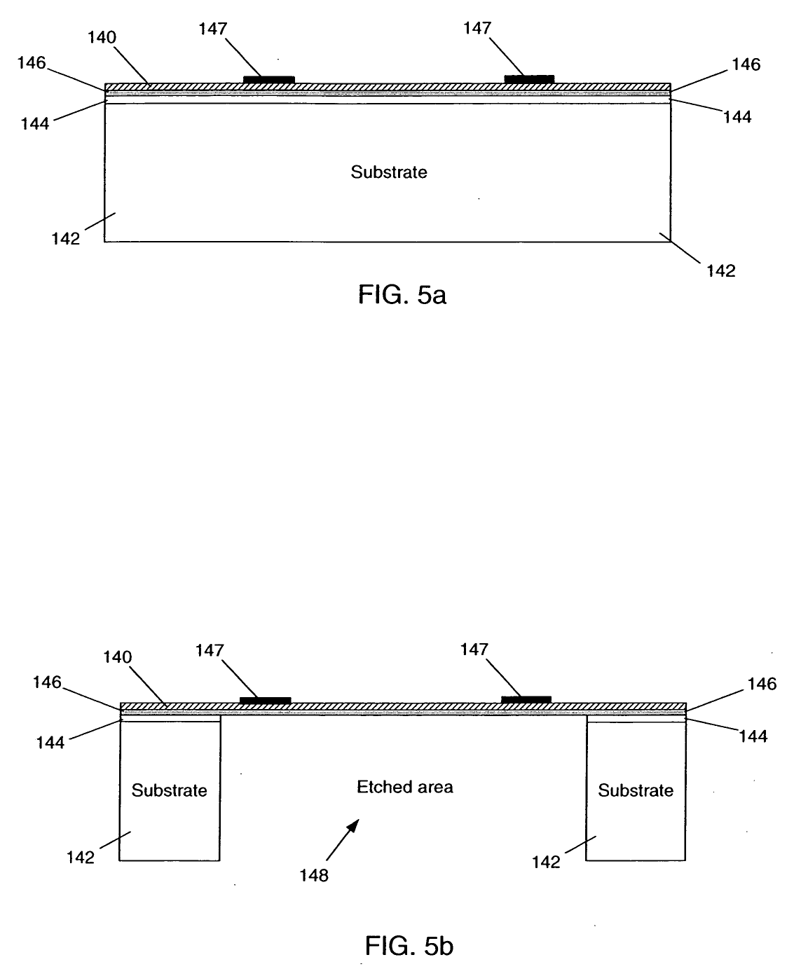

In order to have a low thermal mass and consequently a rapidly tunable thermo-optic filter, one embodiment of the filter 104 employs a thin membrane 140 on a silicon frame. The foundation of the filter 104 is a silicon-on-insulator substrate, which is formed by depositing a 500 nm layer of SiO₂ 142 on a 500-micron thick crystalline silicon wafer 144, then depositing a 300 nm layer of crystalline silicon 146 on top of the SiO₂ layer 142. Multiple films are deposited on the crystalline silicon 146 to form the filter membrane 140, as shown in FIG. 5a (pre-etch). The thin film stack forming the filter membrane 140 includes for example for mid-IR use, alternating layers of amorphous germanium and silicon monoxide. One possible formula for the alternating layers within the membrane is:
(3/4 wave c-Si)L(HL)²4H(LH)³L(HL)³4H(LH)³L(HL)³4H(LH)³L (HL)³4H(LH)³

In this formula L is a quarterwave of silicon monoxide, H is a quarterwave of amorphous germanium, and the quarterwaves are defined relative to 4650 nm. This is a three cavity flat-top filter centered on 4650 nm and a passband about 100 nm. A heater (in this case, a ring heater structure) is disposed on top of the stack of filter layers 140, although in some embodiments the heater may be omitted.

Various etching techniques are used to remove a patterned filter aperture region of the silicon wafer 144 and the SiO₂ layer 142, leaving the thin crystalline silicon layer 146 with the Ge/SiO film stack membrane 140 on top, as shown in FIG. 5b (only one filter from the wafer is shown). The membrane has a thickness of a few micrometers and the active optical aperture is about 2-3 mm. The use of Germanium is advantageous from about 3-12 micrometers. Similar instruments or sensors in the near IR, 1.5-3 micrometers, can be made from amorphous silicon thin films. FIG. 5c shows a top view of the structure in FIG. 5b (looking at the thin film membrane 140). The silicon and germanium materials in the thin films are designed to transmit certain wavelength bands (e.g., 100 nm wide in the 4000 nm to 6000 nm range, with the center wavelength tunable), and absorb shorter wavelengths from the emitter for efficient radiative heating.

In general, the tunable filter membrane structure shown in FIGS. 5a, 5b and 5c can be used as a stand-alone filter, as well as a component of a TOE (or, as described later, a tunable optical detector; TOD). Such a stand-alone membrane filter has many applications other than as part of a chemical sensor. For example, such a tunable filter membrane structure could be used for telecommunications applications, photographic and video equipment, test/measurement equipment, and many others.

As a stand-alone filter, the tunable filter membrane structure includes a heater for varying the temperature of the filter. The heater may be included in the filter membrane structure itself (e.g., by doping one or more of the membrane layers to make them suitably conductive), or on top of the filter membrane (e.g., in the form of a metal ring heater). The resulting filter membrane/heater has a very small thermal mass and is insulated from the supporting frame, which permits fast, uniform and efficient heating of the tunable optical filter element.

Prior art thermo-optic tunable thin film optical filters are tuned using an integrated doped poly-silicon heater deposited on top of a fused silica substrate. The heater is deposited before the filter itself, and is therefore disposed between the filter and the slab. This substrate is a “slab” typically 500 um thick, and with nothing insulating the heater from the substrate, the temperature of the heater cannot rapidly change. The membrane filter of FIGS. 5a, 5b and 5c improves the optical performance of a thermo-optic tunable filter by providing more uniform heating and less optical scattering. It also provides a stable heating element whose resistance can be used to calibrate filter temperature and therefore wavelength. Additionally, it simplifies processing since this filter structure requires no anti-reflection coating.

Further, the prior art thermo-optic tunable thin film optical filters suffer from thermal non-uniformity across the XY-plane (i.e., the plane corresponding to the broad surface shown in FIG. 5c) of the heater. This is a result of the implementation of a sheet heater, which is hotter at the center than at the edges. This non-uniformity translates into a tuning gradient across the filter itself, degrading its optical performance. Additionally, doped poly-silicon heaters have been known to exhibit resistance drift when exposed to high temperature over long periods of time. To counteract this problem, this drift is empirically characterized during an initial calibration process, and compensated for during signal processing. The stabilized the heater resistance of the membrane filter structure of FIGS. 5a, 5b and 5c therefore removes the need for drift compensation.

In one embodiment, such a membrane filter structure is formed by depositing thin film filter layers (as described above, and also in U.S. patent application Ser. No. 10/005,174, filed Dec. 4, 2001; patent application Ser. No. 10/174,503, filed Jun. 17, 2002, and U.S. patent application Ser. No. 10/211,970, filed Aug. 2, 2002, all of which are incorporated herein by reference) on the top surface of an oxidized crystalline silicon (c-Si) wafer. The top surface of the c-Si wafer has been oxidized by, for example, wet oxidation as is known in the art. A ring heater structure 147, along with contact pads for bonding wire connections, is then formed on top of this filter. The contact pads are metallized via, e.g., Ti/Au. From the backside of the wafer, holes or “wells” are then etched into the silicon substrate using photolithography masking techniques known in the art, stopping at the oxide etch stop (this layer protects the filter from being etched). This oxide layer is then removed using an oxide etchant. The result is a thin membrane formed by the blanket-coat filter stack, with a ring heater structure 147 on top.

This approach is somewhat simpler than for prior art methods, resulting in a reduced number of processing steps. The heater is more stable than prior art heaters (e.g., the slab heater described above), and provides more uniform heating to the filter membrane for improved optical characteristics. The heater has a smoother heater surface compared to prior art heaters, which reduces scattering and improves optical characteristics such as insertion loss and adjacent channel rejection. The smaller thermal mass of this tunable membrane filter allows it to change temperature faster than prior art heaters, resulting in faster tuning time constants. The smaller thermal mass also consumes less power than the bulk of prior art heaters.

For the described embodiment, the tunable filter 104 is associated with the blackbody emitter 102, shown symbolically in FIG. 4 with a broken-lined box 118. The two components form a TOE unit 120, which is narrower in spectral output and more widely tunable than prior art low-cost IR sources, because of the spectral control the filter 104 provides.

In an embodiment where the emitter 102 and the filter are thermally coupled, the emitter 102 tunes the filter 104 in temperature (and hence in wavelength) via the thermal coupling as the temperature of the emitter 102 varies. The temperature of the emitter 102 varies according to the amount of current driven through its thin film by the controller 110. This embodiment maintains a constant (or nearly constant) optical power output as the filter 104 is tuned. As described above, the decline in germanium optical transmission with rising temperature (due to materials properties specific to germanium) is offset by the higher power output of the blackbody emitter as its temperature rises. This design therefore requires only one heater circuit, not separate ones for both emitter control and filter thermal tuning.

For a TOE embodiment where the emitter 102 and the tunable filter 104 are not thermally coupled, the tunable filter 104 include its own heating element for changing the filter 104 temperature. A second independent heater circuit from the controller 110 provides the heating current to this heating element.

One way to fabricate the thermally coupled embodiment described above is as follows. The emitter wafer and the filter wafer are bonded back-to-back and diced into individual chips. Each chip consists of a thin film emitter in a silicon substrate frame and a corresponding thin film filter in a silicon frame. The substrates may include other wafer materials known in the art. Since the emitter wafer and the filter wafer were each back-etched to form the respective membranes, as shown in FIG. 5b, placing the wafers back-to-back forms a space between the membranes, which permits radiative heating of the filter by the emitter film as the emitter film ramps in temperature. The overall emission of the resulting TOE device 120 is narrow band and tunable.

By properly choosing the thermal coupling between the emitter 102 and the filter 104, one can design the TOE to provide a specifically-dependent relationship between the temperature of the emitter 102 and the filter 104, such that when the emitter is at 800 degrees C. the filter is at 100 degrees C. and when the emitter is at 1000 degrees C. the filter is at 400 degrees C. (refer to FIG. 2d). This thermal coupling results in a relatively constant IR emission 122 out of the TOE 120 ranging from 4450 to 4570 nm as the temperature of the emitter 102 ranges from 800 degrees C. to 1000 degrees C., due (as described above) to the offsetting relationship between the transmissivity of germanium in the filter 104 and blackbody output of the emitter 102 with respect to temperature.

The thermal coupling between the emitter 102 and the filter 104 is a combination of radiative coupling, convective coupling and conductive coupling, although the radiative coupling predominates and convective coupling is not desirable because of the large time constant associated with it. The amount of radiative coupling is determined by the absorptive spectra of the materials used in the thin film layers, along with the distance between the emitter and filter membranes (i.e., the depth of the thickness of the etched substrates). The conductive coupling can be varied by using different bonding materials, or by placing a spacer with known conductivity between the emitter 102 and filter 104. Convective coupling can be kept low by sealing the TOE in a vacuum or a non-conducting gas.

The multipath gas cell 106 is oriented to receive the tunable, narrow band IR light 122 emitted from the TOE device 120. The multipath gas cell 106, known in the art as a “White” cell includes multiple internal path folds to significantly increase the path length through the sample gas, thereby increasing the magnitude of the absorption peak. One example of such a White cell is the “Ultra-Mini,” manufactured by Infrared Analysis, Inc, which is 10 cm long, but provides a folded optical path of 2.4 meters. The light emitted from the TOE device 120 enters the multipath gas cell 106 through an input lens, passes via the multiple paths through the sample gas within the gas cell 106, and exits the gas cell 106 through an output lens.

The detector 108 receives the light 124 from the multipath gas cell. In the described embodiment, the detector 108 includes a thermopile, i.e., a probe that contains multiple thermocouples. Each thermocouple includes a pair of different metals that creates a small electrical potential when heated. The thermopile thus produces a detection signal 126 that is proportional to the number of constituent thermocouples and the temperature of the thermopile. One example of such a detector is the ST150 thermopile manufactured by Dexter Research, packaged in a TO5 can with a sapphire window and filled with xenon gas.

The controller 110 receives the detection signal 126 from the detector 108 and provides a control signal 128 to the blackbody emitter 102 of the TOE 120. The controller 110 modulates the control signal 128 at 0.5 Hz to cause the temperature of the emitter 102 to oscillate between 700 degrees C. and 900 degrees C. at that frequency. The controller 110 evaluates the resulting detection signal 126 to determine whether an absorption peak is present. The controller can evaluate the detection signal 126 using lock-in detection, derivative detection, or any of several other similar suitable techniques known in the art.

The lock-in tuning mechanism involves delivering the time-varying detection signal 126 to a lock-in amplifier, along with the 0.5 Hz control signal. Lock-in detection is a well-known technique for discriminating small signals in noise (also referred to as synchronous detection—see for example Application Note 3, “About Lock-In Amplifiers,” Stanford Research Systems Inc., www.thinksrs.com). A lock-in amplifier amplifies a signal only within a narrow range of specifically selected frequencies, thereby excluding noise and extraneous signals that fall outside of that range. The lock-in amplifier amplifies the detector signal 126 only in a very narrow band of frequencies centered on 0.5 Hz, which effectively eliminates noise and drift from various sources that occur at other frequencies. The variation in post lock-in detection signal (from the lock-in amplifier) is the sensor output.

If the emitter has a fast enough time constant, the control signal 126 can be superimposed with a “chopping signal” at a higher frequency than the control signal (e.g., 50 Hz). “Chopping” is a noise reduction technique well known in the art of IR signal processing. The filter is not fast enough to respond to the chopping signal, so the filter varies only at the lower frequency of the control signal (i.e., the filter temperature varies with the envelope of the control signal). Other techniques for chopping the emission (e.g., mechanical chopping) could be used in alternative embodiments.

The derivative detection technique involves determining the first (or second) derivative of detection signal 126 as the filter is tuned, and averaging the first (or second) derivative for a number of tuning cycles. In some cases, derivative detection is superior to lock-in detection, particularly when the derivative of the spectral feature (i.e., the absorption peak) presents a unique feature that may be identified by simple computation or analog circuitry (e.g., an analog filter matched to the spectral feature).

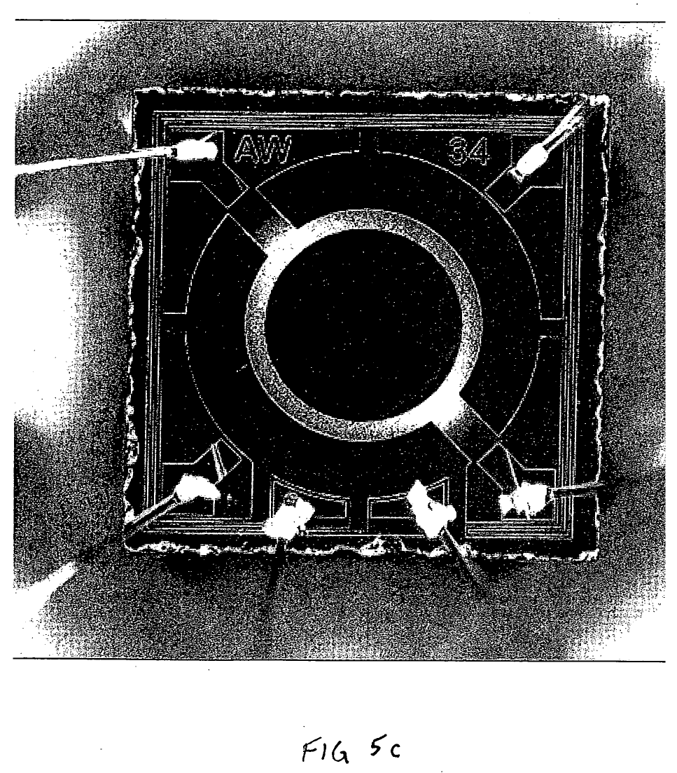

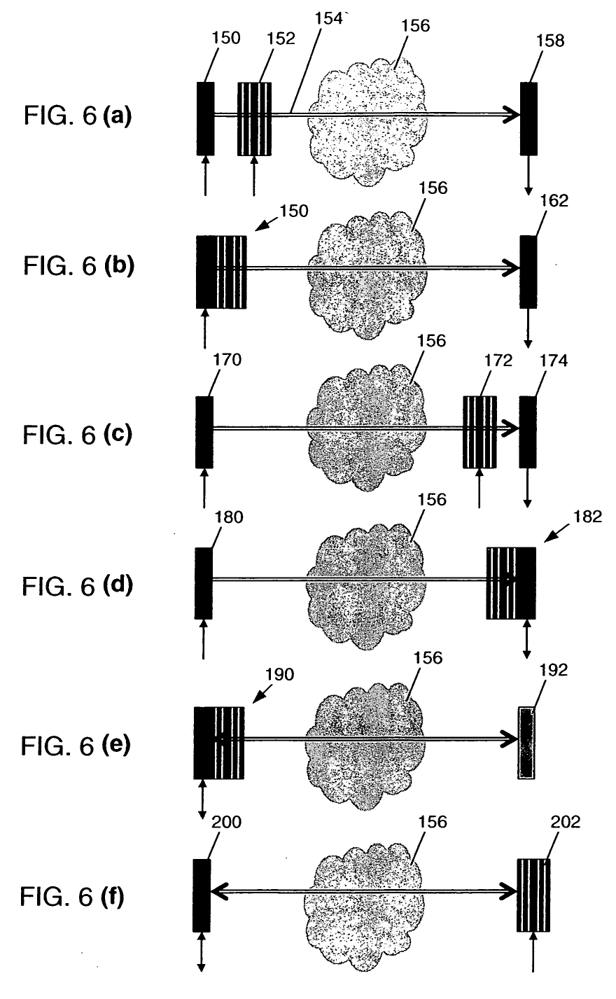

Although the described embodiment uses a tunable emitter to provide spectral variation for detecting a chemical absorption peak, other embodiments using alternative configurations may also be used. Various embodiments of an optical chemical sensor are shown in FIGS. 6a through 6f.

The embodiment in FIG. 6a differs from the described embodiment mainly in the location of the filter 152 with respect to the source 150. A black body radiation source 150 produces broad-spectrum (i.e., broadband) IR radiation. A thermo-optically tunable thin film filter 152 is placed in front of this source 150 and associated circuitry scans the filter 152 to various wavelength settings. The filtered radiation 154 passes through a cavity containing the sample 156 to be measured, and a broadband detector 158 measures radiation intensity after the radiation passes through the sample 156. The associated circuitry measures for a “dip” in the radiation intensity with respect to its wavelength to determine whether a particular chemical is present in the sample, and if so, the chemical concentration from the magnitude of the dip. The filter 152 and the source 150 are not thermally coupled, so the tunable filter 152 includes a heating element for varying the temperature of the filter 152 independent of the source 150. In one embodiment, the heating element includes a thin film metallic ring deposited on the filter.

FIG. 6b shows the configuration of the described embodiment (i.e., FIG. 2), with the emitter bonded to the filter.

The embodiment shown in FIG. 6c differs from the described embodiment in that the tunable filter is located near the detector. A blackbody radiation source 170 produces broad-spectrum IR radiation. The broadband radiation passes through a cavity containing the sample 156, and associated circuitry (not shown) scans an thermo-optically tunable thin film filter 172 to admit different wavelengths of the broadband radiation to a broadband detector 174. The broadband detector 174 measures radiation intensity of the filtered IR radiation from the filter 172. Associated circuitry measures for a “dip” in the radiation intensity with respect to its wavelength to determine whether a particular chemical is present in the sample, and if so, the chemical concentration from the magnitude of the dip.

The embodiment shown in FIG. 6d couples the tunable filter and the detector together to form a tunable optical detector (TOD). This embodiment uses a black body radiation source 180 to produce broad-spectrum IR radiation. The broadband radiation passes through a cavity containing the sample 156. After passing through the sample 156, a combination of a thermo-optic tunable thin film filter and broadband thermal detector 182 receives the broadband radiation. Associated circuitry (not shown) heats filter/detector 182 to scan different wavelengths, while recording the amount of power required to heat the filter/detector 182 to the corresponding temperatures. When less IR radiation reaches the filter/detector 182 (i.e., when the sample 156 absorbs a portion of the IR light), more energy is required to change temperature (and hence the wavelength) of the filter/detector 182. The external circuitry uses this energy differential to calculate the chemical concentration in the sample.

The TOD configuration is useful if the filter, which by virtue of its tuning mechanism must be heated, does not itself radiate so much blackbody radiation as to overwhelm the nearby detector. This is a concern for low cost un-cooled IR detectors such as thermopiles, which are essentially micro-thermometers, as opposed to the photon-detectors, which in many applications are not feasible due to their relatively high cost. The package containing the TOD components may be filled with a gas such as xenon to improve the response of the thermopile detector.

The embodiment of FIG. 6e uses a single combination of a blackbody emitter blackbody detector/thermo-optically tunable filter 190. The combination is heated to emit wavelength-scanning narrowband infrared radiation. This radiation passes twice through a cavity containing a sample 156 with the aid of a retro-reflector 192. The back-reflected radiation is filtered and absorbed in the blackbody emitter/detector combination 190. Similar to the embodiment shown in FIG. 6d, associated circuitry (not shown) heats the combination 190 to scan different wavelengths, while recording the amount of power required to heat the combination 190 to the corresponding temperatures. When less IR radiation reaches the combination 190, more energy is required to change temperature (and hence the wavelength) of the combination 190. The external circuitry uses this energy differential to calculate the chemical concentration in the sample.

The embodiment of FIG. 6f uses a combined blackbody emitter/detector 200 to produce broadband IR radiation that passes through a cavity containing a sample 156. A thermo-optically tunable thin film filter 202 reflects a narrowband portion of this IR radiation. Associated circuitry (not shown) scans the filter 202 in wavelength. The blackbody emitter/detector 200 reabsorbs the reflected narrowband portion of the IR radiation after the radiation passes back through the sample 156. Similar to the embodiments shown in FIGS. 6d and 5e, associated circuitry (not shown) heats the emitter/detector 200 to scan different wavelengths, while recording the amount of power required to heat the emitter/detector 200 to the corresponding temperatures. When less IR radiation reaches the emitter/detector 200, more energy is required to change temperature (and hence the wavelength) of the emitter/detector 200. The external circuitry uses this energy differential to calculate the chemical concentration in the sample.

In general, the embodiments described in FIGS. 6a through 6f are closely interrelated, with the different types of emitters and detectors in use at different wavelengths. At mid IR wavelengths, low cost emitters include blackbody hot sources (e.g., hot wires and conductive membranes) and low cost detectors include uncooled thermopiles or pyroelectric devices. At near IR wavelengths, low cost emitters include LEDs, and low cost detectors are photon detectors such as PIN photodiodes. At near IR wavelengths, both sources and detectors are much more efficient than those used for mid IR wavelengths.

As a practical matter, these factors restrict the use of a tunable optical detector (TOD-FIGS. 6d and 6e) implementation to useful wavelengths in the near IR (less than 2000 nm), where the radiation from the filter heated to 200-300 C, compared to the IR radiation being measured, will not overwhelm the detector. For spectroscopy of (for example) CO₂ at the 2000 nm overtone band, or other trace gases with absorptions in the 1400 nm to 1800 nm range, a TOD may be used. At these shorter wavelengths, the typical emitter includes an LED, since a blackbody emitter would require an impractically high temperature to serve as an effective near IR source.

For longer wavelengths, for example 4600 nm, the TOD is impractical because the hot filter will overwhelm a thermopile detector placed within a few millimeters of separation. In this case the tunable optical emitter (TOE-FIG. 6b) configuration is the better choice.

A tunable optical filter (TOF-FIGS. 6a and 6c) configuration, in which the packaged tunable filter is placed in an optical system in such as a way as to be associated with neither emitter or detector, are also used in alternative embodiments. The embodiments described herein are all based on the tunable filter, whether implemented as TOE, TOD or TOF.

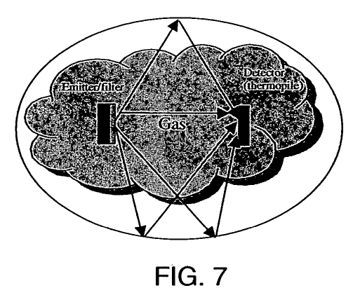

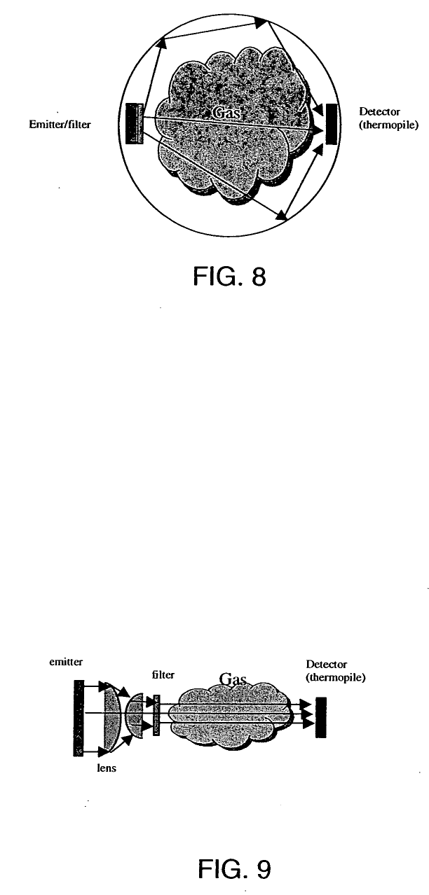

Other embodiments increase the optical power reaching the detector from the emitter to increase the signal resolution and accuracy of the optical chemical sensor (other than using a back-reflector as shown in FIGS. 2a and 2d). One technique for increasing the optical power at the detector is to place the emitter/filter and the detector at the loci of an elliptical mirrored cavity, as shown in FIG. 7. Another technique for maximizing optical power at the detector is place the emitter/filter and the detector in an optical integrating sphere, as shown in FIG. 8. Yet another technique is to utilize a separate, large, high-power broadband (i.e., blackbody) emitter and focus the light from the emitter via suitable optics through a smaller tunable filter element, as shown in FIG. 9. The smaller area of the tunable optical filter keeps the operating voltage low, and focusing of the light from the larger emitter increases the optical power density at the detector.

Other aspects, modifications, and embodiments are within the scope of the claims.

1. An optical sensor for detecting a chemical in a sample region, comprising:
an emitter for producing broadband light which travels along a light path that passes through the sample region;
a detector for producing a detection signal corresponding to the light the detector receives, wherein the detector is disposed in the light path; and,
an optical filter having a tunable passband for selectively filtering the light traveling in the light path, wherein the passband of the optical filter is tunable by varying a temperature of the optical filter.

2. The optical sensor of claim 1, further including a controller for controlling the passband of the optical filter, wherein the controller modulates the passband of the optical filter across a wavelength range.

3. The optical sensor of claim 1, further including a controller for receiving the detection signal from the detector, wherein the controller analyzes the detection signal to determine whether an absorption peak of the chemical is present.

4. The optical sensor of claim 1, wherein the broadband light has a black body spectrum.

5. The optical sensor of claim 1, wherein the emitter and the optical filter are thermally coupled, so that varying a temperature of the emitter correspondingly varies the temperature of the optical filter, thereby tuning the optical filter in wavelength.

6. The optical sensor of claim 5, wherein the emitter and optical filter are thermally coupled through thermal radiation.

7. The optical sensor of claim 5, wherein the emitter and optical filter are thermally coupled through thermal conduction.

8. The optical sensor of claim 1, wherein the optical filter includes a heating element for varying the temperature of the optical filter independent from the emitter.

9. The optical sensor of claim 1, wherein (i) the emitter includes a thin film membrane mounted on a first substrate frame, and (ii) the emitter and optical filter are bonded together, so as to form a tunable optical emitter (TOE).

10. The optical sensor of claim 1, wherein the controller periodically modulates the passband at a predetermined frequency about an absorption peak of the chemical, and analyzes the detection signal for a variation corresponding to the absorption peak of the chemical.

11. The optical sensor of claim 10, wherein the controller analyzes the detection signal using a lock-in detection technique.

12. The optical sensor of claim 1, wherein the controller (i) evaluates a derivative of the detection signal as the controller modulates the center wavelength of the optical filter, and (ii) averages the derivative of the detection signal for two or more passband modulation cycles to detect an absorption peak of the chemical.

13. The optical sensor of claim 1, wherein the optical filter is disposed in close proximity to the detector, so as to form a tunable optical detector (TOD).

14. The optical sensor of claim 1, wherein the emitter, the detector and the optical filter are disposed in close proximity to form an emitter/detector/filter combination; and,
further including a retro-reflector for reflecting the light back to the combination; and,
a controller for controlling the passband of the optical filter and for receiving the detection signal from the detector, wherein the controller calculates an amount of power necessary to change the temperature of the optical filter, and determines whether an absorption peak of the chemical is present therefrom.

15. The optical sensor of claim 1, wherein the emitter and the detector are disposed in close proximity to form an emitter/detector combination; and,
a controller for controlling the passband of the optical filter and for receiving the detection signal from the detector, wherein the controller calculates an amount of power necessary to change the temperature of the optical filter, and determines whether an absorption peak of the chemical is present therefrom.

16. A tunable optical emitter for producing light having a wavelength spectrum that is translatable across a range of wavelengths, comprising:
an optical source for producing light having a first wavelength spectrum;
an optical filter having a tunable passband for selectively filtering the light from the optical source, wherein the optical filter receives light from the optical source and produces filtered light having a second wavelength spectrum, such that the first wavelength spectrum includes the second wavelength spectrum, and wherein the passband of the optical filter is tunable by varying a temperature of the optical filter.

17. The tunable optical emitter of claim 16, wherein the optical source and the optical filter are thermally coupled, so that varying a temperature of the optical source correspondingly varies the temperature of the optical filter.

18. The tunable optical emitter of claim 16, wherein the optical source and optical filter are thermally coupled through thermal radiation.

19. The tunable optical emitter of claim 17, wherein the optical source and optical filter are thermally coupled through thermal conduction.

20. The optical sensor of claim 16, wherein the optical filter includes a heating element for varying the temperature of the optical filter independent of a temperature of the optical source.

21. The optical sensor of claim 16, wherein (i) the optical source includes a thin film membrane on a first silicon frame, (ii) the optical source and optical filter are bonded together

22. An optical filter membrane structure having a tunable passband, comprising:
a filter membrane of two or more stacked thin film layers on a substrate frame, wherein the passband is tunable by varying a temperature of the filter membrane; and,
a heater associated with the filter membrane for tuning the passband across a wavelength range.

23. The optical filter membrane structure of claim 22, wherein the heater includes a ring heater structure formed on the top of the filter membrane.

24. The optical filter membrane structure of claim 22, wherein the filter membrane is formed by (i) depositing the two or more stacked thin film layers on a front surface of a silicon wafer, and (ii) etching away an aperture on the back surface of the silicon wafer, such that a remaining portion of the silicon wafer forms a silicon frame around a filter membrane.

25. The optical filter membrane structure of claim 22, wherein the heater includes a radiative emitter radiating IR radiation toward the filter membrane.

26. The optical sensor of claim 22, wherein the filter thin film membranes include germanium.

27. The optical sensor of claim 22, wherein the filter thin film membranes include silicon.
